(19) United States
(12) Patent Application Publication
(10) Pub. No.: US 2016/0223002 A1
(43) Pub. Date: Aug. 4, 2016

(54) FASTENING ASSEMBLY, RECEIVING ELEMENT, INSERTION ELEMENT AND LATCHING ASSEMBLY

(71) Applicants: Edwin Jeroen MULLER, Delft (NL); BUILDEX (F.E.) LIMITED, Wanchai (CN)

(72) Inventors: Edwin Jeroen Muller, TA Delft (NL); Jakov Yoav Karasanti, Ningbo (CN); Emiel Dimitri Karasanti, Ningbo (CN); Yusheng Li, Jiaojiang District (CN)

(21) Appl. No.: 15/025,278

(22) PCT Filed: Sep. 30, 2014
(86) PCT No.: PCT/NL2014/050667

§ 371 Date: Mar. 27, 2016

(30) Foreign Application Priority Data
Sep. 30, 2013 (NL) 2011531

(51) Int. Cl. F16B 12/26; A47C 4/02; A47B 5/02; F16B 5/00; A47B 13/00

(52) U.S. Cl. CPC F16B 12/26; F16B 5/0052; A47B 13/003; A47B 5/02; A47C 4/02

(57) ABSTRACT

The present invention relates to a fastening system comprising a first element having a first latching surface, a second element having a second contact surface abutting the first contact surface, and a locking device having first and second latching members interconnected via a locking body of a diameter generally corresponding to the diameter of the fastening channels and via an elastic element that is attached to the first latching member and to the second latching member for allowing elastic displacement of the second latching member, the diameter of the elastic element being smaller than a diameter of the access slot, wherein the first latching member is placed in contact with the first latching surface, the locking body extending through first and second fastening channels, the second latching member being biased against a second contact surface or against a further contact surface spaced at a distance from the second contact surface.

### OBJECT OF THE INVENTION

The present invention relates to a fastening system for mutually fastening elements according to the preamble of claim 1. Moreover, the present invention relates to an element for use in a fastening system according to the present invention. Furthermore, the present invention relates to an element for use in a fastening assembly according to the present invention. Additionally, the present invention relates to a locking device for use in a fastening assembly according to the present invention.

### BACKGROUND OF THE INVENTION

Many ways have been developed to mutually fasten parts of assemblies. An example thereof is that many ways have been developed to mutually connect boards. An example thereof is a mortise dowel joint as well as connections in which perpendicular boards are connected by means of a cross nut inserted in a hole in one blank, in which nut a screw is fastened with screw is connecting the perpendicular board. Many home assembly cupboards are based on this principle.

In DE 3739743, a fastening system is shown, comprising a telescopic connecting element having a ball-shaped end, which is connected to a rod element, and an opposite ball-shaped end being connected to a tube element, in which the rod element is inserted to. A compression spring is connected to the rod element in such a way that the ball-shaped ends can be moved apart from each other in a longitudinal direction and against the force of the spring. The telescopic connecting element is used to connect adjacent block members, by connecting the ball-shaped ends into a groove provided in each of the adjacent block members.

Such ways of mutually fastening do however require complex handling and handling of several parts simultaneously.

### OBJECT OF THE INVENTION

In order to provide an alternative way of fastening, the present invention provides a fastening assembly for mutually fastening of two elements, such as sheet units, comprising:
a receiving element,
an insertion element comprising an insertion member for insertion thereof into a receipt position of the receiving element,
at least one receiving position, arranged in the receiving element, preferably shaped by means of a receiving opening or a receiving recess,
a locking assembly, comprising two latching members and a biasing member for urging towards each other of the latching members, in which at least one of the latching members comprises a locking member for providing a locking between the insertion element and the receiving element:
at least one channel arranged in the receiving element for cooperation with a locking assembly,
in which the channel extends to two sides from the receiving position.

When applying such a fastening assembly, it becomes e.g. possible to assemble furniture or toys based on boards or sheets by means of simple manual steps. An advantage thereof is that the parts, such as the boards or the sheets, may be packaged, transported towards the end user in a flat stacking on top of each other. A further advantage is that the furniture or toys can be disassembled after use, and can be stored until later use with minimal use of space. A further advantage is that parts may be easily replaced for e.g. altering the attention value of the product, by e.g. exchanging elements by elements with a different color or different design.

Further areas of use for applying a fastening assembly according to the present invention relates to e.g. a window extender, clothing hooks, carriers for shelves, but the areas of use are not limited to these examples.

According to a first preferred embodiment, in the fastening assembly, the channel has at least partially a diameter for receiving the locking member, preferably from one side of the channel, therewith forming a locking channel. This provides an advantageous embodiment for providing a mutual locking of the receiving element and in the insertion element by means of the locking member. It is envisioned that use of one channel suffices for such an embodiment.

In a further preferred embodiment it is envisioned that at least one end of the channel ends at an edge of the receiving element, further preferably in which two ends of the channel end at two edges of the receiving element. Because of this, advantageously, a firm and two-sided attachment can be realized in which for example jiggle or play according to a one-sided connection is prevented.

According to a further preferred embodiment, in the locking assembly, two latching members are arranged at two respective ends of the biasing member, in which the biasing member is elongated. By means of this, a simple mounting and operating is provided. A user, even a small child, can pull a latching member that is for example embodied as a bead for freeing the locking member from the insertion elements.

Further preferably, a fastening assembly is provided in which a first latching member of the locking assembly is suitable for placement in a latching member recess for therein fastening of an end of the biasing member, and a second latching member of the locking assembly is suitable for operating the locking assembly by pulling the second latching member. Such an embodiment is single-sidedly operable for a fastening assembly at the edge of for example a blade element in which the locking assembly is directed inwardly from the edge.

Further preferably, both latching members of the locking assembly are suitable for operating the locking assembly by pulling thereof. Such a variant is two-sidedly operable in which from two sides a locking member may be operated by means of the latching members. Because of this, and insertion element may be fastened from two sides, which requires a slightly more complex assembly but also prevents inadvertent disassembly because disassembly has to be initiated from two sides before disassembly occurs. Furthermore, by means of one locking assembly, two or more insertion elements may be fastened by means of such a double-sided locking assembly.

By means of an assembly in which an end of the channel ends in the latching member recess, preferably embodied as an opening, through hole or recess, that is arranged at an end of the channel at a distance from an edge of the receiving elements, fastening of the non-operated latching member of a single-sidedly operable latching member is achieved in an advantageous manner.

Further preferably, one of the two latching members is arranged in a respective latching member recess. Because of this, the biasing member may be kept under bias from the side. In case the fastening of the latching member to the biasing member is realized during production it is provided as a further advantage that the fastening assembly may be packaged and handled as sheet parts in which outside the surfaces of the sheets no parts extend, such that a stack of sheets does not need to be thicker than the sum of the thickness of the parts of the sheets, which, next to for example the easy assembly and disassembly because no loose parts are required for assembly of the assembly, is an important advantage of the present invention. With this, it is advantageous in case there are one or two latching member recesses per locking assembly for holding the respective latching members.

In a further preferred embodiment, the fastening assembly comprises a biasing member access slot for providing access of the biasing member to the channel, which is preferably arranged at a location of the part of the channel that forms the locking channel in an insertion direction of the insertion member, wherein the biasing member access slot is connected with the edge of the insertion member. Herewith, in a simple manner, it is realized that the insertion member can be inserted in the receiving element, whereby the biasing member and the bias is capable of bringing the locking member into the locking position.

Further preferably, the receiving element comprises a reinforcement slot for reinforcing the coupling between the receiving element and the insertion element, in which preferably the reinforcement slot is arranged in an extension direction of the insertion element relative to the receipt position. In for example the table embodiment as described in the following, this reinforcement slot provides the option of inserting an extra supporting part into the tabletop which increases the carrying strength as well as the resistance to horizontal push forces.

In an embodiment in which the insertion element is suitable for coupling with a receiving element by means of two or more fastening assemblies, it is achieved that several plate elements are suitable for coupling such as a several legs for a table or several boards in a cupboard. With more complex constructions, further respective construction possibilities are possible, such as hinge-able constructions such as is described in the following under reference to the drawings.

Applying a receiving position at an angle between 45-135° relative to a surface of the receiving element provides an additional reinforcement against for example horizontal or transverse forces but also for example appearance advantages such as in cases in which this feature provides a familiar character for e.g. a table.

In a further preferred embodiment, the insertion element comprises a receiving slot for receiving a receiving position holding part of the receiving member, wherein a bottom of the receiving slot fulfills the function of the insertion member, preferably comprising a respective biasing member access slot, which further preferably provide access to a respective locking channel part in the respective insertion member. Relating to this embodiment, reference is made to the description of e.g. FIG. 5.

In a further preferred embodiment, one or both of the latching members have a shape to cooperate with a shape of the receiving element, further preferably with a shape for the purpose of optimal grip or a high attention value. The shape may be shape of a bead, but also a shape that extends flush in cooperation with a surface of the receiving element. Herewith, either remark ability or discreteness of the latching member may be achieved. Furthermore, a high level of grip may be provided or opposed to that no grip depending on the application. Grip in itself is advantageous for latching members that serve the purpose of operating the latching members, but even in such cases, operability may be sacrificed for a noticeable or discrete exterior.

In a further preferred embodiment two receiving positions share a channel for mutual application of a latching assembly, in which the channel preferably extends from the receiving positions in both directions, in which further preferably one or two locking channels are formed in the channel.

A further aspect of the present invention relates to a latching assembly according to the present invention for use in a fastening assembly according to the present invention.

A further aspect of the present invention relates to a receiving element according to the to present invention for use in a fastening assembly according to the present invention.

A further aspect of the present invention relates to an insertion element according to the present invention for use in a fastening assembly according to the present invention. In an embodiment of the present invention a fastening system comprising; a first element having a first latching surface, a first contact surface and a first fastening channel extending from the first latching surface to the first contact surface, a second element having a second contact surface abutting the first contact surface, spaced at a distance therefrom a second surface and a second fastening channel extending from the second contact surface to the second contact surface in line with the first fastening channel, wherein an access slot of smaller diameter than a diameter of the fastening channels extends from the second fastening channel to an outer surface of the second element and extending parallel to the channel along its length, and a locking device having first and second latching members interconnected via a locking body of a diameter generally corresponding to the diameter of the fastening channels and via an elastic element that is attached to the first latching member or to the locking body and to the second latching member for allowing elastic displacement of the second latching member, the diameter of the elastic element being smaller than a diameter of the access slot, wherein the first latching member is placed in contact with the first latching surface, the locking body extending through the first and second fastening channels and the second latching member being biased against the second contact surface or against a further contact surface spaced at a distance from the second contact surface.

Additionally, a further fastening channel section extends from the second contact surface to a recess formed in a perimeter of the first element.

Moreover, the second latching member is placed in contact with the second contact surface in such a way that the locking device can be operated by pulling from the second latching member in a direction opposite from the second latching surface.

In an embodiment of the invention, the first and second latching members are provided with a different cross-sectional shaped form.

Besides, the first element comprises a reinforcement slot for reinforcing the coupling between the first element and the second element, in which the reinforcement slot is arranged in an extension direction of the second element relative to a receipt position.

Moreover, the second element is provided for coupling with a first element of an adjacent fastening system by means of a locking device.

In an embodiment of the invention, a receiving position relative to the first contact surface of the first element is arranged at an angle between 10-117°, and preferably an angle between 45-135°.

In an embodiment of the present invention, an element for use in a fastening system comprising a latching surface, a contact surface and a fastening channel extending from the latching surface to the contact surface, wherein an access slot of smaller diameter than a diameter of the fastening channel extends from the second fastening channel to an outer surface of the element.

Moreover, the element is further provided with a further fastening channel section extending from a second contact surface to a recess formed in a perimeter of the element.

The present invention also relates to a locking device for use in a fastening system having first and second latching members interconnected via a locking body (33) of a first diameter that is attached to the first latching member and to an elastic element that is attached to the first latching member or to the locking body and to the second latching member for allowing elastic displacement of the second latching member, the diameter of the elastic element being smaller than a diameter of the locking body, wherein the second latching member is placed at a distance from the locking body in unreleased state.

Moreover, the locking body is attached to the first or the second latching member at one of its ends and its opposing end is positioned at a distance from said latching member.

Additionally, the elastic element is partially outstanding from the end of the locking body.

In an embodiment, the length of the elastic element that is outstanding from the end of the locking body is about 0.1-0.5 the total length of the elastic element.

In an embodiment of the present invention, the outer diameter of the elastic element is equal or smaller than the inner diameter of the locking body, when the elastic element is in release state.

Furthermore, the first and second latching members comprise a different cross-sectional shape from each other.

These aspects provide advantages as described relating to the above described aspects.

### BRIEF DESCRIPTION OF THE DRAWINGS

Further advantages, features and details of the present invention will be further elucidated on the basis of a description of one or more embodiments with reference to the accompanying figures.

FIG. 1 relates to a first preferred embodiment of a fastening assembly of a part of a table.

FIG. 2 relates to a further preferred embodiment of a fastening assembly of a part of a chair.

FIG. 3a relates to a further preferred embodiment of a fastening assembly in detail.

FIGS. 3b-d relate to a further preferred embodiment of a fastening assembly in detail.

FIG. 4 relates to a further preferred embodiment of a fastening assembly.

FIG. 5 relates to a further preferred embodiment of a fastening assembly.

FIG. 6 relates to a further preferred embodiment of a fastening assembly.

FIG. 7 relates to a further preferred embodiment of a fastening assembly.

FIG. 8 relates to a further preferred embodiment of a fastening assembly.

FIG. 9 relates to a further preferred embodiment of a fastening assembly.

FIG. 10 relates to a further preferred embodiment of a fastening assembly.

### DETAIL DESCRIPTION OF THE INVENTION

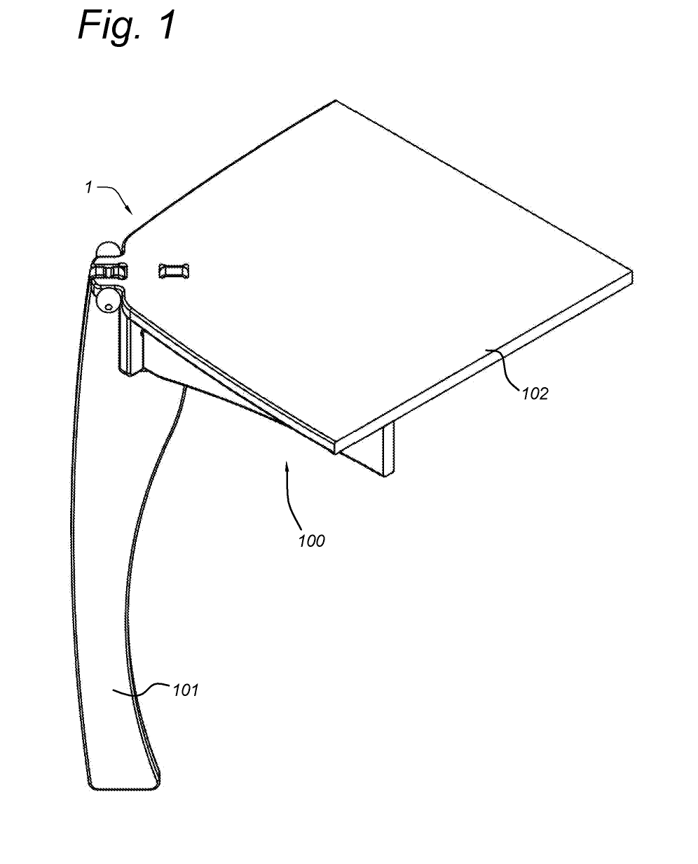

A first preferred embodiment (FIG. 1) according to the present invention relates to a fastening assembly or system 1 which is applied in a table 100. The table comprises a table leg 101, table top 102 and a fastening assembly 1, wherein the tabletop serves as a receiving element, the leg serves as insertion element and the respective parts of the fastening assembly in a preferred embodiment are part of the tabletop and the table leg. Preferably, at least all table legs are fastened to the tabletop by means of fastening assemblies 1, such as described in greater detail below.

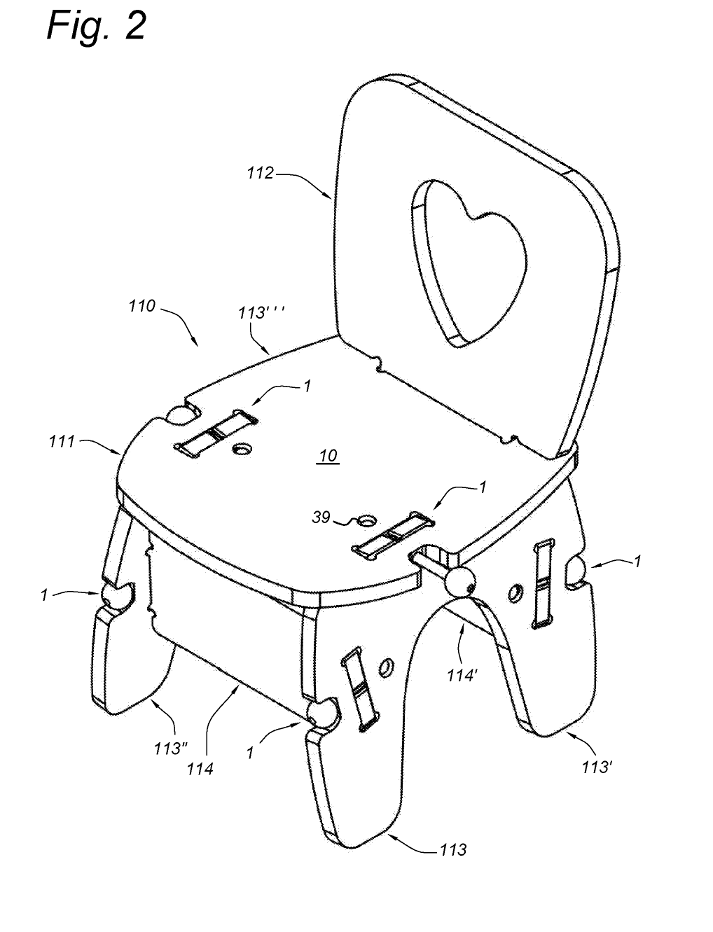

A further preferred embodiment (FIG. 2) according to the present invention finds application in a chair 110. The chair comprises a seat 111, backrest 112, chair legs 113, 113′, 115″, 113′″ and cross connections 114, 114′, wherein preferably a cross connection 114′ and a backrest is created as one part. The distinct parts of the chair are preferably all mutually fastened by means of respective fastening assemblies 1.

An aspect of this embodiment is that the seat of the chair serves the purpose of receiving element for the two shown fastening assemblies. These two fastening assemblies for which the seed serves the purpose of receiving element, the legs 113, 113′ respectively 113″, 113′″ serve the purpose of insertion element. However, for the connections with the cross connections 114, 114′, the legs serve the purpose of receiving element.

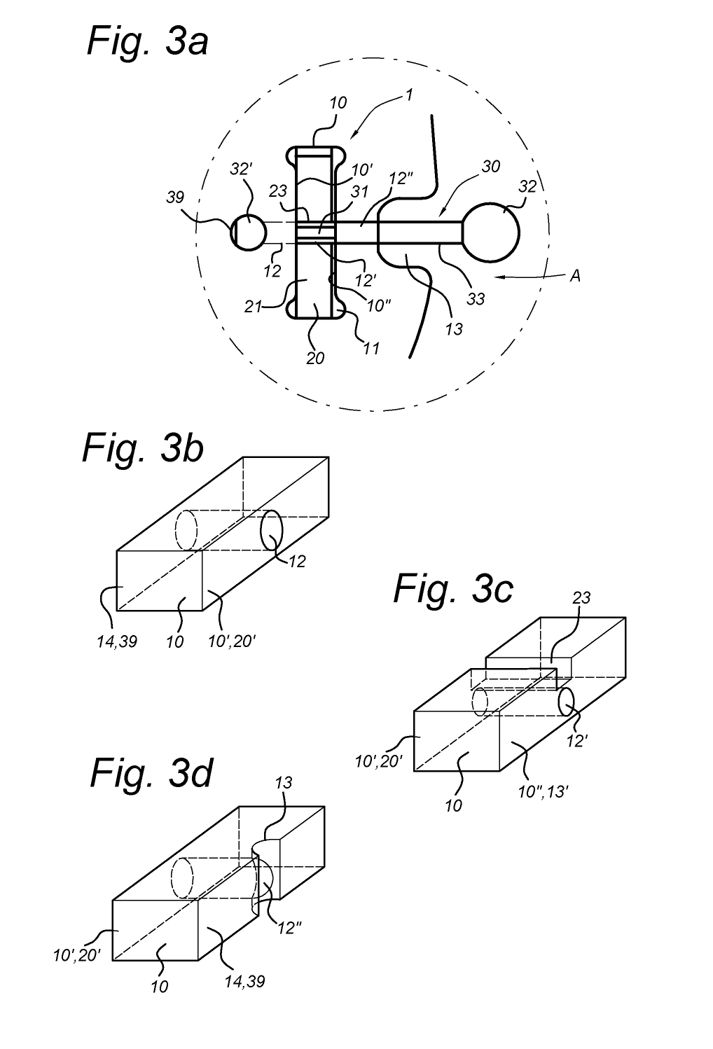

In FIG. 3a, a fastening assembly is shown in detail. This fastening assembly or system comprises a receiving position 11, an insertion member 20, also referred as a second element 20, and a locking assembly 30. The receiving element 10 comprises an operating recess 13 that is arranged at one side of the receiving element. From the operating recess a first part of a channel 12′, also referred as a fastening channel 12′, that is formed in the receiving element extends. The channel connects the operating recess with a receiving position 11. Following on from the first part of the channel, at an opposing side of the receiving position, a second part of the channel 12 is arranged, wherein the second part of the channel connects the receiving position with a latching member recess 39.

The insertion member 20 is inserted in the receiving position of the receiving element. The insertion member is preferably elongated for providing additional firmness to the fastening assembly or system.

The locking assembly is shown in FIG. 3a in an extended condition for allowing placing of the insertion element in the receiving position. The locking assembly comprises a biasing member, such as an elastic member and or pulling member that is preferably elongated for causing of a pulling together force in the extended condition. In the extended condition, the biasing member is present in the receiving position in a stretched out condition wherein the locking member is present in the general part 12′, the recess 13 and/or outside thereof. The biasing member access slot 23 is arranged as a side of the insertion member for allowing access of the biasing member. The biasing member is suitable for insertion thereof through the biasing member access slot. In the locking position, the locking member extends through the channel part 12; locking channel that follows on from the channel part 12 through the insertion member and the channel part 12′.

The locking assembly comprises to latching members 32, 32′ for keeping the biasing member 51 under bias. A first locking member 32′ is arranged in the locking member recess 39 for keeping therein of the first locking member. A second looking member 32 is arranged at the operating recess 13 in a locking position. In the extended condition, such as in FIG. 3, the second latching member is kept under bias in the direction of the arrow A by means of the biasing member.

The biasing member 31 extends from the latching member 32′to which it is fastened to the latching member 32 to which it is fastened.

The operating recess 13 serves the purpose of providing reachability to the latching members 32 for taking out the fastened condition of the locking assembly. A further advantage of arranging the latching member in the operating recess is that the latching member is at least partly arranged within the shape of the receiving element and therefore poses no hindrance to the user during use of the furniture.

As illustrated, the receiving element or first element 10 comprises a pair of spaced apart contact surfaces 10′, 10″. A first contact surface 10′ is connected to a second contact surface 10″ via a second fastening channel 12″. A first fastening channel 12 is provided at the first contact surface 10′ of the first element 10. A second fastening channel 12″ is provided at the second contact surface 10″ of the element 10. A locking device 30 is illustrated comprising the biasing member 31 extending from the latching member 32′, to which it is fastened to the latching member 32 to which it is fastened to. The second element 20 also comprises a first contact surface 10′ spaced at a distance therefrom a second contact surface 10″,13′ and a second fastening channel 12′ extending from the second contact surface 10′, 20′ to the second surface 10″,13′ in line with the first fastening channel 12, wherein an access slot 23 of smaller diameter than a diameter of the fastening channels 12,12′ extends from the second fastening channel 12′ to an outer surface of the second element 20 and extending parallel to the channel along its length.

The second latching member 32 comprises a locking member 33. The locking member preferably comprises a recess or hollow space along the longitudinal axis for arranging in there of a part and or end of the biasing member. By means of this recess or hollow space an additional space is provided for advantageously providing space for a relatively long biasing member with a relative small ratio between the length in extended condition and in the locking condition of the biasing member. This advantageously provides that a biasing member with relatively less elastic reach can be used. In the locking condition, the locking member extends over at least a part of the receiving position, preferably the whole receiving position, further preferably a part of channel part 12, channel part 12′ and the whole receiving position. Because the locking member cannot pass through the biasing member access slot, it is achieved that the inserted insertion member is locked into the receiving position when the locking assembly is in the locking condition.

FIGS. 3b-3d show different embodiments of an element 10, 20 for use in a fastening assembly or system, as described above. The element 10 as illustrated in FIG. 3b comprises a latching surface 14, 39. A fastening channel 12, embodied as a through-opening, is provided extending along the longitudinal direction. The fastening channel 12, 12′ extends from the latching surface 14, 39 to a contact surface 10′, being the contact surface 10′ at a parallel distance from the latching surface 14, 39. Moreover, the embodied element 10 comprises a substantially rectangular shape, but the skilled person will appreciate that the embodied shape of the element 10 is not limited to a substantially rectangular shape.

In FIG. 3c, an element 20 is shown, comprising a contact surface 10′, 20′, a fastening channel 12′ and an access slot 23 extending from the latching surface 10 to a second contact surface 10″, 13′. It should be noted that the recess channel 23 may be directly connected to the fastening channel 12′, such that a locking device 30 (not illustrated) can be directly inserted via the access slot 23 into the fastening channel 12′. The skilled person will appreciate that the fastening channel 12′ and the access slot 23 are illustrated as a separate parts, but this is only for illustration purposes. It should be understood that these parts are connected. In other words, the access slot 23 is directly connected to the fastening channel 12′. In this manner, the fastening channel 12′ is accessible via the access slot 23.

FIG. 3d illustrates a further element 10 comprising a contact surface 10′, 20 and a fastening channel 12″ extending from the contact surface 10′, 20 to a latching surface 14, 39. The latching surface 14, 39 comprises a recess 13 formed in the perimeter of the element 10, and more particularly on the perimeter of the fastening channel 12″ section. The recess 13 is formed comprising an angle of about 30°-45°. It is not illustrated, but the skilled person will appreciate that when the locking device 30 is in connected position, the first latching member 32 of the locking device 30 will be prompt against the recess 13. In this manner, a strong and steady connection is provided between the elements 10, 20 of the fastening system, and the locking device 30.

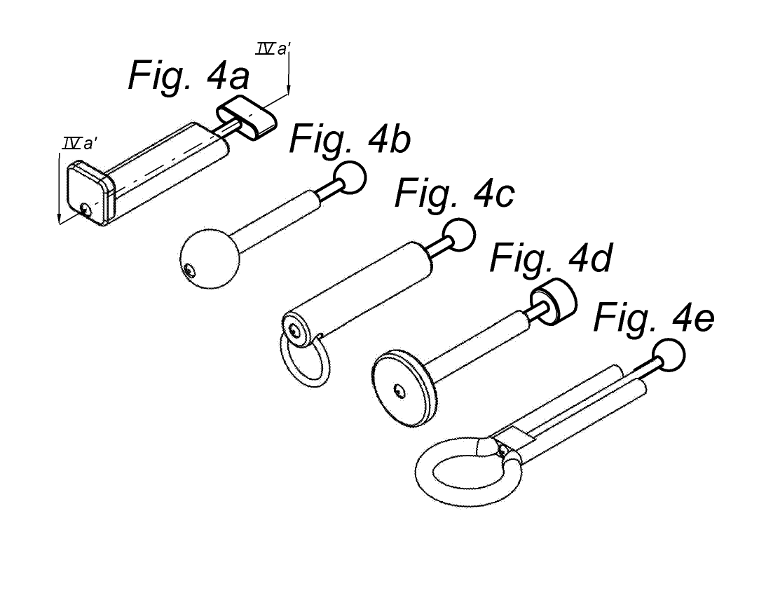

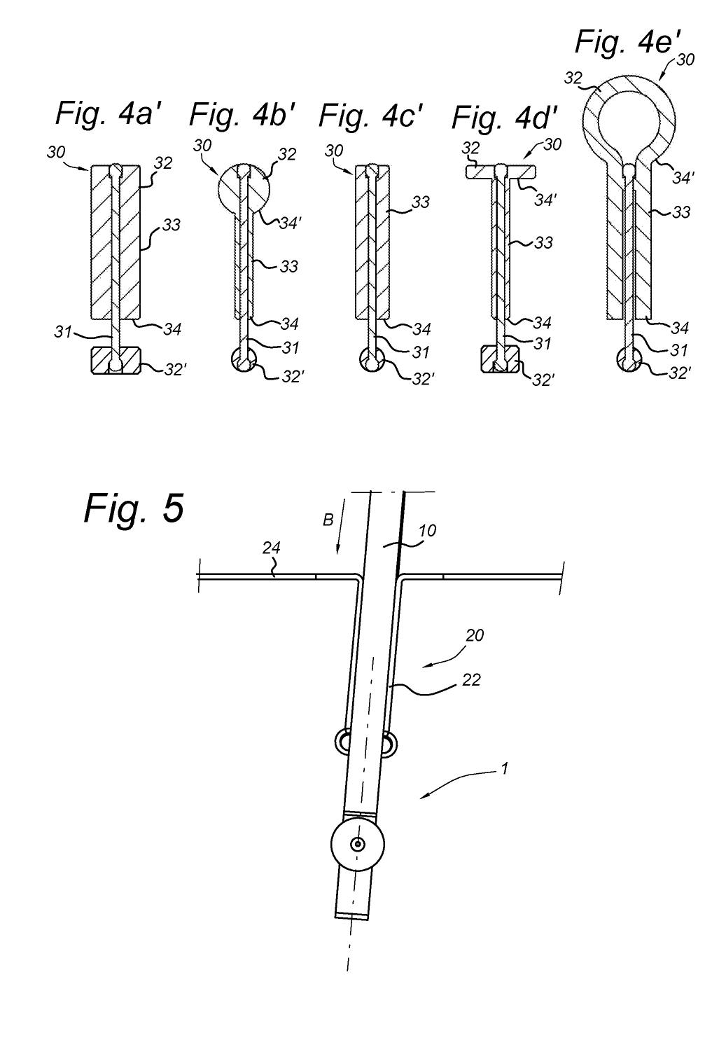

Further preferred embodiments (FIG. 4) according to the present invention relates to a number of locking assemblies 30. These locking assemblies 30 each comprise a biasing member 31, two latching members 32, 32′ and a locking member 33.

The different locking assemblies comprise latching members 32, 32′ with different shapes for arranging in preferably complementary shaped latching member recesses 39 and operating recesses 13 depending on the purpose of the exterior thereof, such as described in the above.

A further preferred embodiment (FIG. 5) according to the present invention relates to a fastening assembly for fastening of two flat elements under a different usual orientation then described in the above. In this embodiment, the insertion member also comprises a receiving slot 22 for partially receiving of the receiving member. By means of the overlap that is provided after insertion, a relatively strong fastening is achieved.

The fastening is achieved by means of partly shifting into each other of the elements. During insertion in a direction of the arrow B of the receiving element in the insertion element, the receiving element is inserted into the receiving slot 22.

The longitudinal axis C of the intercession element is oriented under an angle relative to his side 24 of the receiving elements. Furthermore, this embodiment functions with a locking assembly in a channel in a similar manner as the embodiment shown in FIG. 3.

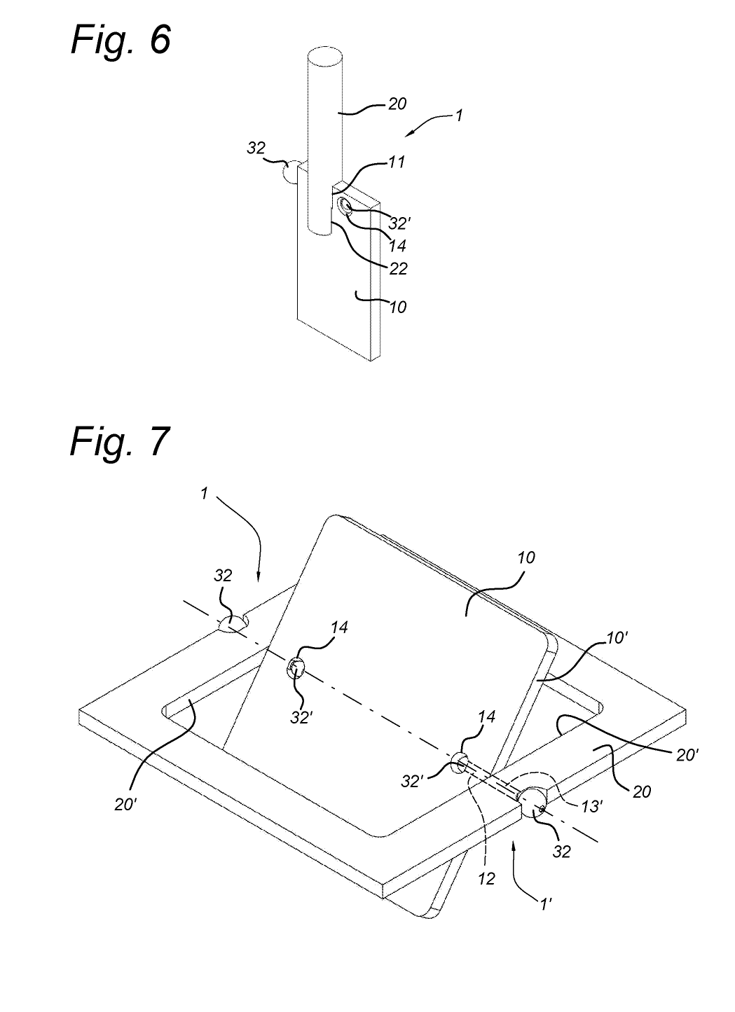

A further preferred embodiment (FIG. 6) relates to a fastening assembly for fastening of a flat element to a cylinder shaped element.

This connection is achieved by means of partially sliding into each other of the elements. During insertion in the direction of the arrow B of the receiving elements 20 in the insertion element, the receiving element 10 is moved into the receiving slot 22.

A latching member recess 14 is shown for insertion of a latching member 32′. Advantageously, the latching member 32′ is arranged within the dimensions of the receiving element.

A further preferred embodiment (FIG. 7) according to the present invention relates to a fastening assembly for fastening of two flat elements. In this embodiment, a rotatable panel is functional as insertion elements 20. In this embodiment, the biasing member access slots 23 is formed in the frame panel 20 for transverse access of the biasing member when the knob 32 is located in an extended position, extended relative to the retracted position that is shown.

As in the other embodiments, the difference in thickness between the biasing member and the locking member combines both the locking and the ability to pass the biasing member through the biasing member access slot 23.

By means of this fastening, these two elements are rotatable relative to each other around a rotational axis E in the mounted condition. This way of fastening of 2 elements can be applied in an advantageous manner by rotatably fastening of a hatch, cap and/or a door.

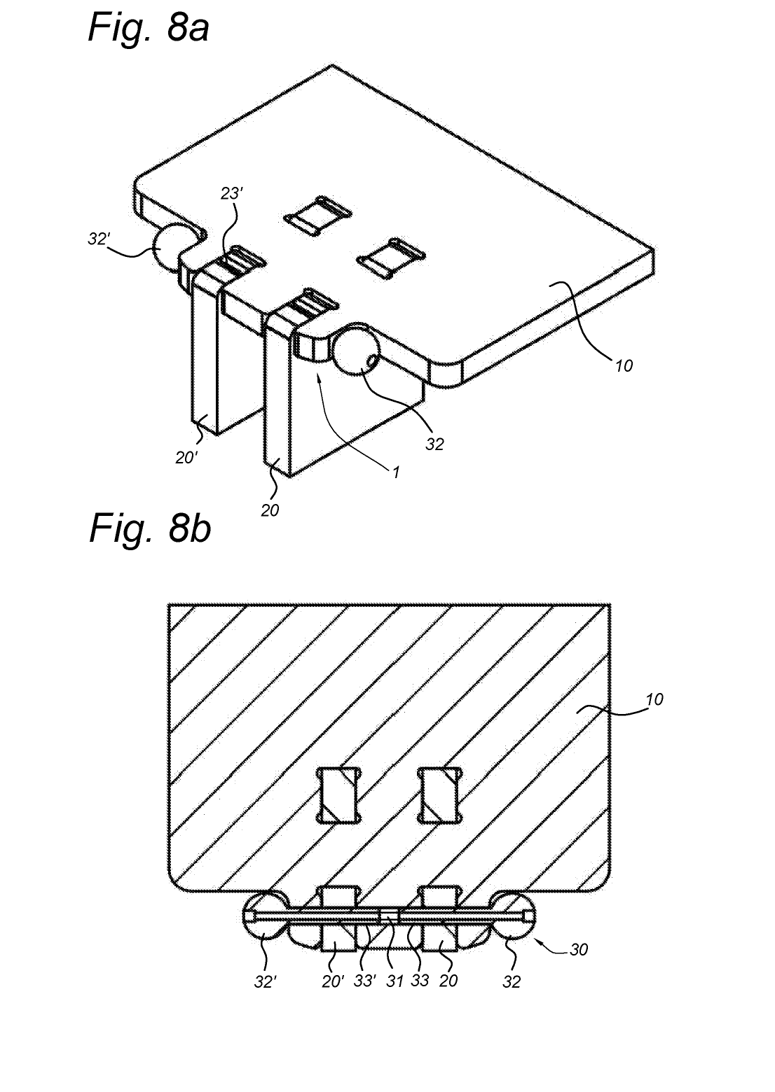

A further preferred embodiment (FIG. 8) according to the present invention relates to a fastening assembly for fastening of three flat elements. The fastening assembly 1 comprises a receiving element 10, two insertion elements 20, 20′ and a locking assembly 30. The locking assembly 30 comprises two latching members 32, 32′ and a biasing member 31.

By means of the substantially symmetrical embodiment of the latching members 32, 32′ with respective locking members 33, 33′, advantageously a fastening assembly for two insertion elements 20, 20′ is provided. The biasing member 31 features an elasticity that suffices to unlock one side or both sides simultaneously.

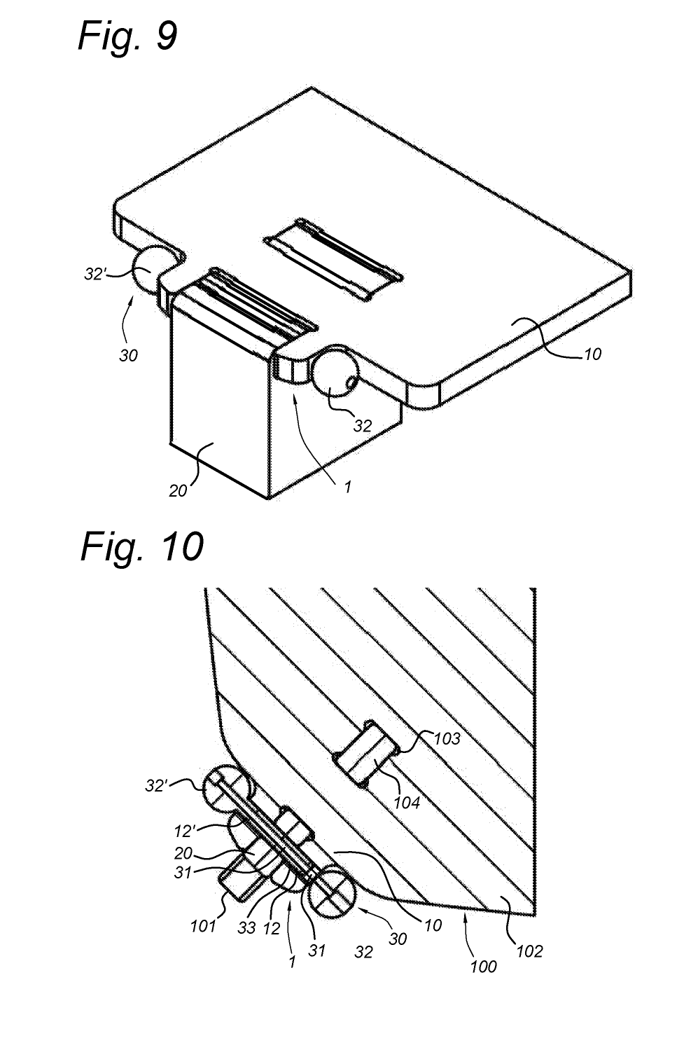

A further preferred embodiment according to FIG. 9 relates to a fastening assembly for fastening of two flat elements with different dimensions. The fastening assembly 1 comprises a receiving element 10, an insertion element 20 and a locking assembly 30. The insertion element is embodied from thicker plate material than the receiving element. The locking assembly comprises two latching members 32, 32′ and a biasing member 31.

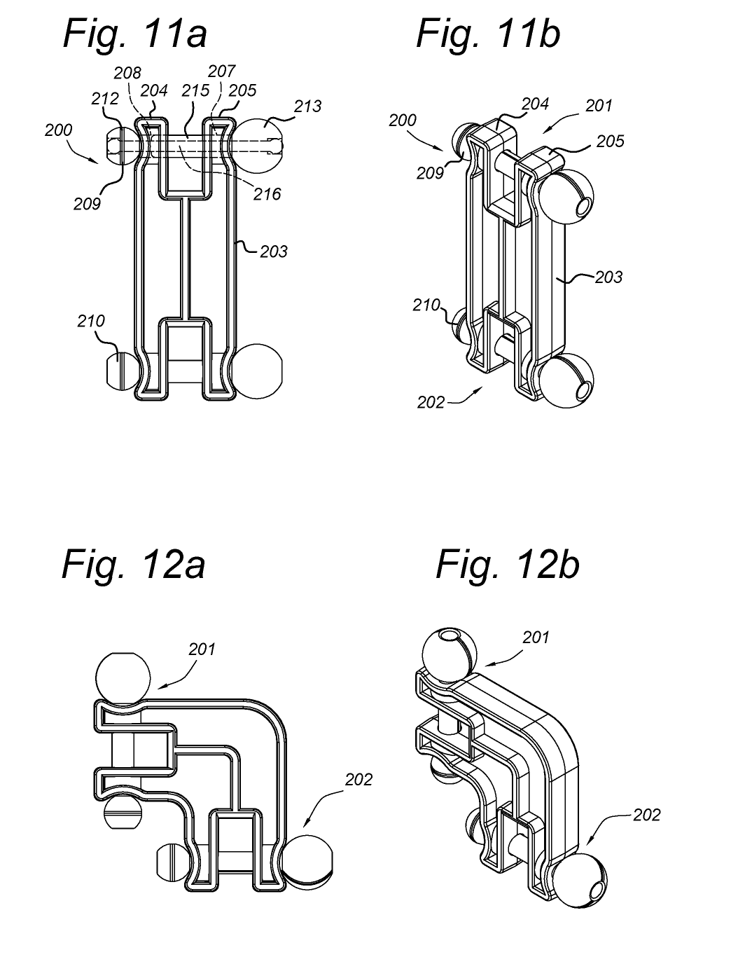

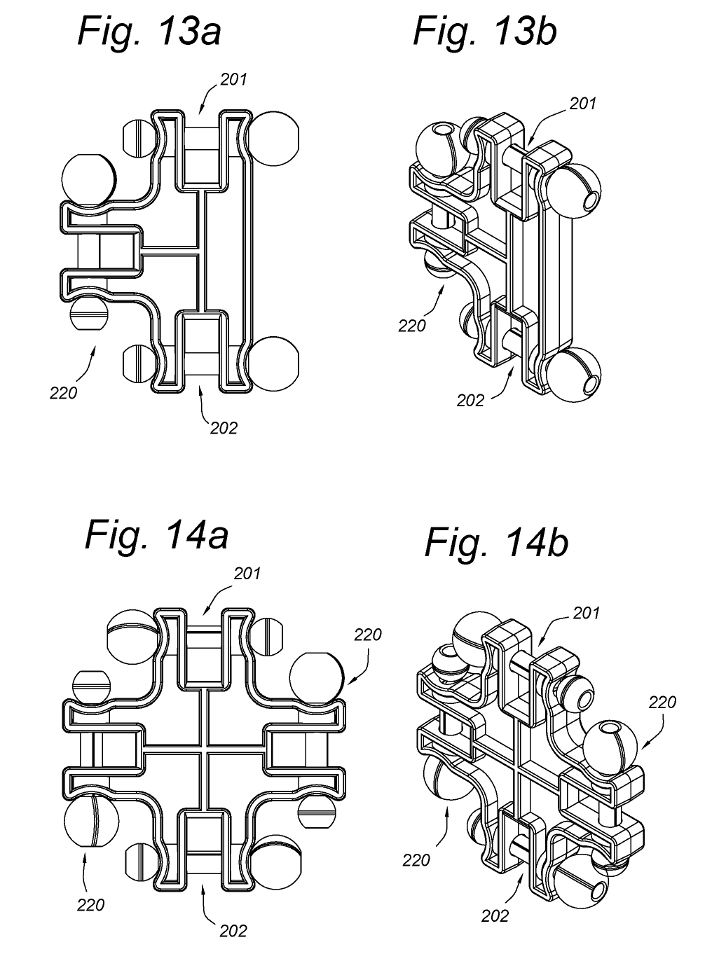

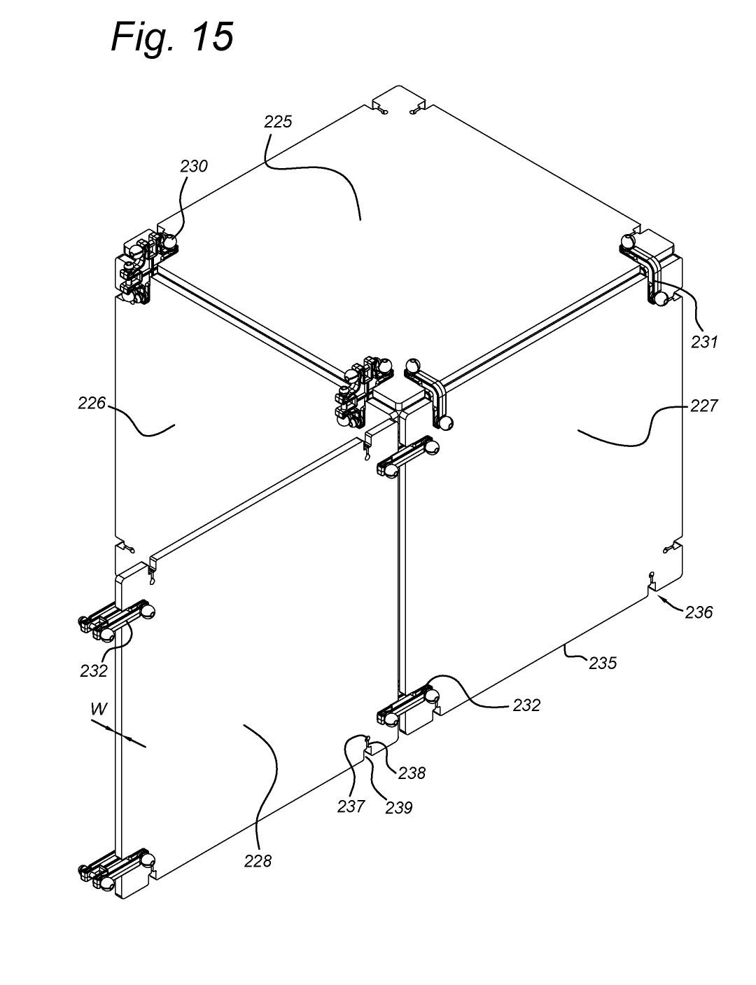

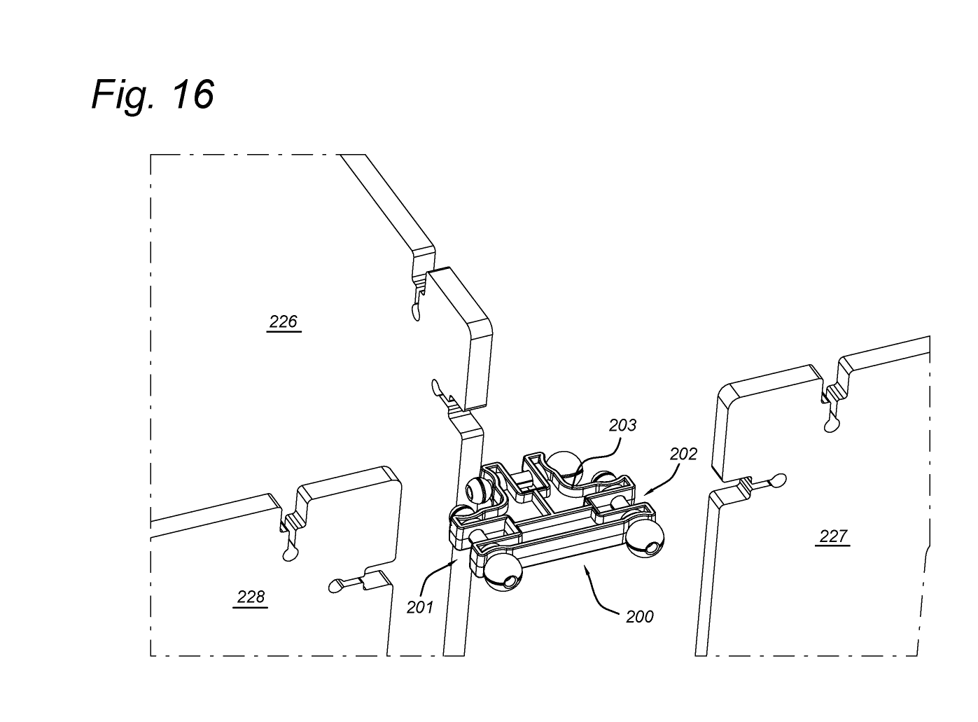

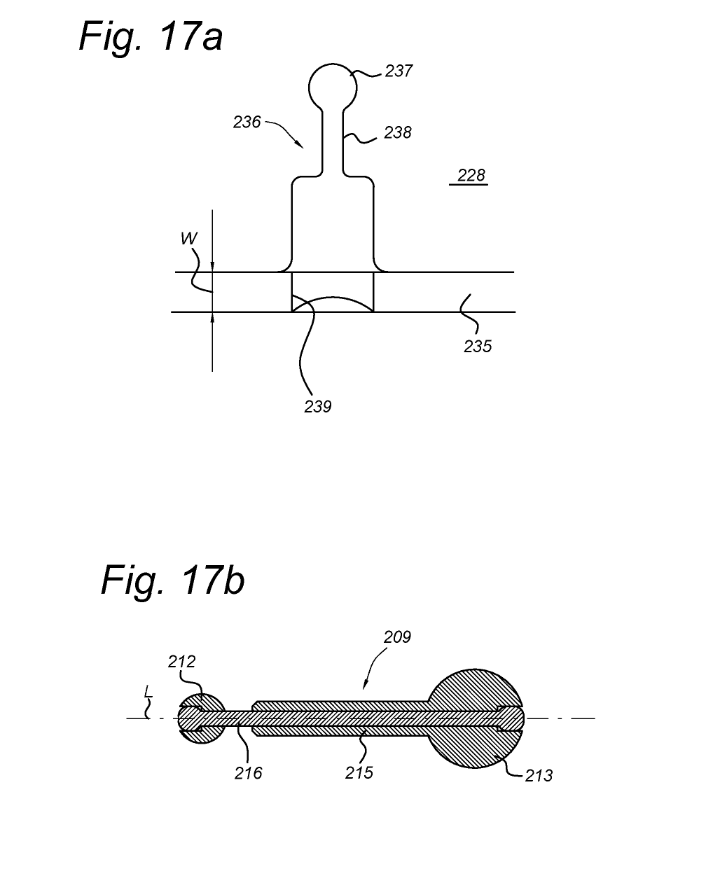

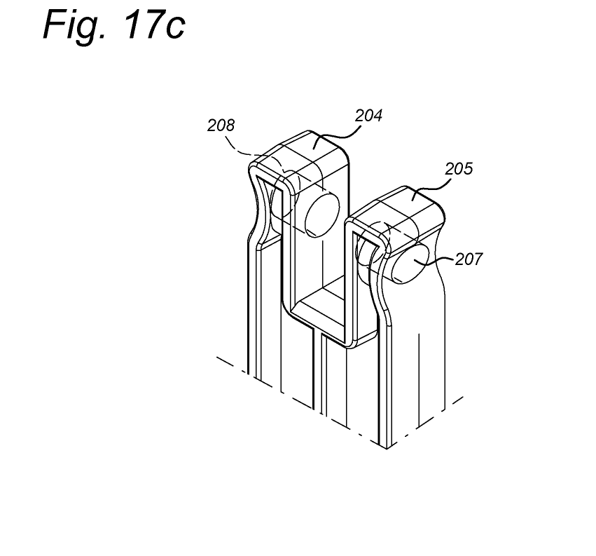

In FIG. 10, the fastening assembly according to FIG. 1 is shown in greater detail. The latching member 32 is connected to the latching member 32′ by means of a biasing member 31 which is fastened in the respective knobs of the latching members. Because of this, the stretching length of the biasing member extends from knob to knob. The latching member 32′ comprises a locking member that extends from knob 32 via channel part 12′and the locking channel into channel part 12.

The insertion element 10 comprises insertion member 20 that is insert able into the receiving position 11. To reinforce the connection, a reinforcement slot 103 is provided for receiving the reinforcement member 104 which is arranged at the top side of the table leg in order to be arrangeable in the reinforcement slot while the fastening element is mounted.

The present invention is described in the foregoing on the basis of several preferred embodiments. Different aspects of different embodiments can be combined, wherein all combinations which can be made by a skilled person on the basis of this document must be included. These preferred embodiments are not limitative for the scope of protection of this document. The rights sought are defined in the appended claims.

1-15. (canceled)

16. A fastener assembly comprising:
an elongated assembly further comprising first and second latching members at the distal ends,
a locking member attached to one of the latching members, and a connecting elastic biasing member,
said first and second elements each having respective access channel s accommodating said locking member and said connecting elastic biasing member therein,
said fastener assembly used to connect said first element to said second element while allowing disassembly and reattachment without the use of tools.

17. The fastener assembly as in claim 16 further comprising a fastening system for latching said first element to said second element,
said first element having a first latching surface, a first contact surface and a first fastening channel extending from the first latching surface to the first contact surface;
said second element having a second contact surface abutting the first contact surface spaced at a distance therefrom a second contact surface and a second fastening channel extending from the second contact surface to the second surface in line with the first fastening channel, wherein an access slot of smaller diameter than a diameter of the fastening channels extends from the second fastening channel to an outer surface of the second element and extending parallel to the channel along its length; and
a locking device having said first and second latching members interconnected via a locking body of a diameter generally corresponding to the diameter of the fastening channels and via said elastic biasing member, said elastic biasing member being an elastic element that is attached to said first latching member or to the locking body and to said second latching member for allowing elastic displacement of said second latching member, the diameter of the elastic element being smaller than a diameter of the access slot, wherein said first latching member is placed in contact with the said first latching surface, the locking body extending through said first and second fastening channels and said second latching member being biased against the second contact surface or against a further contact surface spaced at a distance from the second contact surface.

18. The fastening system according to claim 17, wherein a further fastening channel section extends from the second contact surface to a recess formed in a perimeter of the first element.

19. The fastening system according to claim 17, wherein the second latching member is in contact with the second contact surface in such a way that the locking device can be operated by pulling from the second latching member in a direction opposite from the second latching surface.

20. The fastening system according to claim 18, wherein the second latching member is in contact with the second contact surface in such a way that the locking device can be operated by pulling from the second latching member in a direction opposite from the second latching surface.

21. The fastening system according to claim 17, wherein the first and second latching members are provided with different cross-sectional shaped forms.

22. The fastening system according to claim 18, wherein the first and second latching members are provided with different cross-sectional shaped forms.

23. The fastening system according to claim 19, wherein the first and second latching members are provided with different cross-sectional shaped forms.

24. The fastening system according to claim 17, wherein the first element comprises a reinforcement slot for reinforcing the coupling between the first element and the second element, in which the reinforcement slot is arranged in an extension direction of the second element relative to a receipt position.

25. The fastening system according to claim 18, wherein the first element comprises a reinforcement slot for reinforcing the coupling between the first element and the second element, in which the reinforcement slot is arranged in an extension direction of the second element relative to a receipt position.

26. The fastening system according to claim 19, wherein the first element comprises a reinforcement slot for reinforcing the coupling between the first element and the second element, in which the reinforcement slot is arranged in an extension direction of the second element relative to a receipt position.

27. The fastening system according to claim 20, wherein the first element comprises a reinforcement slot for reinforcing the coupling between the first element and the second element, in which the reinforcement slot is arranged in an extension direction of the second element relative to a receipt position.

28. The fastening system according to claim 17, wherein the second element is provided for coupling with a first element of an adjacent fastening system using a locking device.

29. The fastening system according to claim 18, wherein the second element is provided for coupling with a first element of an adjacent fastening system using a locking device.

30. The fastening system according to claim 19, wherein the second element is provided for coupling with a first element of an adjacent fastening system using a locking device.

31. The fastening system according to claim 20, wherein the second element is provided for coupling with a first element of an adjacent fastening system using a locking device.

32. The fastening system according to claim 21, wherein the second element is provided for coupling with a first element of an adjacent fastening system using a locking device.

33. The fastening system according to claim 17 wherein a receiving position relative to the first contact surface of the first element is arranged at an angle between 10-117°, and preferably an angle between 45-135°.

34. The fastening system according to claim 18 wherein a receiving position relative to the first contact surface of the first element is arranged at an angle between 10-117°, and preferably an angle between 45-135°.

35. The fastening system according to claim 19 wherein a receiving position relative to the first contact surface of the first element is arranged at an angle between 10-117°, and preferably an angle between 45-135°.

36. The fastening system according to claim 20 wherein a receiving position relative to the first contact surface of the first element is arranged at an angle between 10-117°, and preferably an angle between 45-135°.

37. The fastening system according to claim 21 wherein a receiving position relative to the first contact surface of the first element is arranged at an angle between 10-117°, and preferably an angle between 45-135°.

38. The fastening system according to claim 22 wherein a receiving position relative to the first contact surface of the first element is arranged at an angle between 10-117°, and preferably an angle between 45-135°.

39. The fastening system according to claim 23 wherein a receiving position relative to the first contact surface of the first element is arranged at an angle between 10-117°, and preferably an angle between 45-135°.

40. The fastening system according to claim 17, wherein the second latching member is in contact with the second contact surface in such a way that the locking device can be operated by pulling from the second latching member in a direction opposite from the second latching surface.

41. A locking device for use in a fastening system comprising:
first and second latching members interconnected via a locking body;
said locking body comprising a hollow member of first diameter that is attached at one end thereof to the first latching member;
said locking body having an elastic element that is attached to the first latching member and to the second latching member for allowing elastic displacement of the second latching member with respect to the first latching member, the elastic element having a second diameter smaller than a diameter of the hollow body,
wherein the second latching member is spaced from the locking body in unreleased state.

42. The locking device according to claim 41, wherein the hollow body is attached at one end thereof to the first latching member and an opposing, free end thereof is positioned at a distance spaced from said second latching member.

43. The locking device according to claim 42, wherein the elastic element connects both first and second latching members.

44. The locking device according to claim 43, wherein the length of the elastic element that is outstanding from the free end of the locking body is about 0.1-0.5 a total length of the elastic element.

45. The locking device according to claim 43, wherein an outer diameter of the elastic element is equal or smaller than the inner diameter of the locking body, when the elastic element is in the release state.

46. The locking device according to claim 41, wherein the first and second latching members comprise a different cross-sectional shape from each other.
